(19) United States
(12) Patent Application Publication
(10) Pub. No.: US 2015/0363781 A1
(43) Pub. Date: Dec. 17, 2015

(54) METHODS AND SYSTEMS FOR PROVIDING PAYMENT CREDENTIALS

(71) Applicant: VISA INTERNATIONAL SERVICE ASSOCIATION, San Francisco, CA (US)

(72) Inventor: Cornelius Johannes Badenhorst, Eversdal (ZA)

(21) Appl. No.: 14/762,771

(22) PCT Filed: Feb. 26, 2014
(86) PCT No.: PCT/IB2014/059254

§ 371 Date: Jul. 22, 2015

(30) Foreign Application Priority Data
Feb. 26, 2013 (ZA) 2013/01440

(51) Int. Cl. G06Q 20/40

(52) U.S. Cl. CPC G06Q 20/4014

(57) ABSTRACT

The invention provides systems and methods for providing payment credentials usable in a transaction. A method conducted at a token processor, the token processor receives a request for single-use payment credentials from a communication device of a consumer. In response, the token processor obtains or generates single-use payment credentials and obtains or generates a loyalty identifier which is uniquely associated with the consumer. The token processor then transmits the single-use payment credentials and the loyalty identifier to the communication device as a combined single-use payment token capable of being presented using the communication device. In some embodiments, the loyalty identifier is the same for all requests by the consumer for single-use payment credentials, such that the loyalty identifier is usable by a merchant in updating a record of the consumer.

### BACKGROUND

Merchants may make use of reward mechanisms such as loyalty programs to incentivize consumers to consistently shop at their outlets. For instance, consumers who are signed up with the merchant's loyalty program may receive loyalty points every time they shop at that merchant. These points can then, for example, be redeemed for products or a cash-back.

These reward mechanisms typically require that the consumer be identified by the merchant each time a purchase is made. Present methods of identifying consumers include making use of merchant loyalty cards. Such methods may require the consumer to carry multiple loyalty cards for each merchant with whom they have a loyalty account, and may also require the selection and presentation of an appropriate loyalty card when purchasing a product. Present methods can thus be an inconvenience to consumers and can slow down the process of purchasing products.

Other ways of identifying consumers include recording consumers' payment credentials, such as primary account numbers (PANs) or derivatives thereof. The problem with this method is that payment credential data is subject to strict rules as to how and under what circumstances it may be stored and processed, making the storing of payment credential data for identifying a consumer undesirable.

Merchants also desire means for conveniently providing coupons to consumers.

### BRIEF SUMMARY

In accordance with a first aspect of the invention, there is provided a method for providing payment credentials usable in a transaction, the method being conducted at a token processor and comprising the steps of:

receiving a request for single-use payment credentials from a communication device of a consumer;

obtaining or generating single-use payment credentials;

obtaining or generating a loyalty identifier being uniquely associated with the consumer;

transmitting the single-use payment credentials and the loyalty identifier to the communication device as a combined single-use payment token capable of being presented using the communication device.

A further feature of the invention provides for the loyalty identifier to be the same for all requests by the consumer for single-use payment credentials, such that the loyalty identifier is usable by a merchant in updating a record of the consumer.

A still further feature of the invention provides for the loyalty identifier to be the same for all requests by the consumer for single-use payment credentials usable at a specific merchant such that the loyalty identifier is usable by the specific merchant in updating a record of the consumer.

A yet further feature of the invention provides for the record to be a record of transactions by the consumer at the merchant, and for the record to include details of products purchased from the merchant by the consumer.

A further feature of the invention provides for the step of obtaining or generating a loyalty identifier being uniquely associated with the consumer to include obtaining a loyalty identifier included in the request.

Still further features of the invention provide for the step of obtaining or generating a loyalty identifier being uniquely associated with the consumer to include the steps of: obtaining a consumer identifier included in the request; and, using the consumer identifier to query a database and obtain a loyalty identifier associated with the consumer identifier.

Yet further features of the invention provide for the step of transmitting the single-use payment credentials and the loyalty identifier to the communication device as a combined single-use payment token to include a step of encoding the single-use payment credentials and the loyalty identifier into one or more of the group of: a quick response (QR) code; an audio stream or near-sound communication audio stream; an optical character recognition code; a near field communication data stream; or a visible light communication data stream.

Further features of the invention provide for the method to include the step of: obtaining coupon information corresponding to one or more coupons; and wherein the step of transmitting the single-use payment credentials and the loyalty identifier to the communication device as a combined single-use payment token includes transmitting the single-use payment credentials, the loyalty identifier and coupon information to the communication device as a combined single-use payment token.

In accordance with a second aspect of the invention, there is provided a method for providing payment credentials usable in a transaction, the method being conducted at a communication device of a consumer and comprising the steps of:

transmitting a request for single-use payment credentials;

receiving single-use payment credentials;
wherein the single-use payment credentials and a loyalty identifier are received as a combined single-use payment token capable of being presented using the communication device; or
wherein the single-use payment credentials are received and locally combined with a loyalty identifier to form a single-use payment token;

presenting the single-use payment credentials and the loyalty identifier as a combined single-use payment token to a payment acceptance device and wherein the loyalty identifier is uniquely associated with the consumer.

A further feature of the invention provides for the step of transmitting a request for single-use payment credentials to include a loyalty identifier in the request.

A still further feature of the invention provides for the step of transmitting a request for single-use payment credentials to include a consumer identifier in the request.

A yet further feature of the invention provides for the step of receiving single-use payment credentials and a loyalty identifier as a combined single-use payment token to include receiving the combined single-use payment token from a token processor.

Further features of the invention provide for locally combining single-use payment credentials and a loyalty identifier as a combined single-use payment token to include: receiving single-use payment credentials from a token processor; obtaining a loyalty identifier being uniquely associated with the consumer; and, combining the single-use payment credentials and loyalty identifier into a combined single-use payment token.

A still further feature of the invention provides for the step of obtaining a loyalty identifier being uniquely associated with the consumer to obtain the loyalty identifier from a digital memory of the communication device.

In accordance with a third aspect of the invention, there is provided a method for providing payment credentials usable in a transaction, the method being conducted at a payment acceptance device of a merchant and comprising the steps of:

receiving single-use payment credentials and a loyalty identifier as a single-use payment token being presented by a communication device of a consumer, wherein the loyalty identifier is uniquely associated with the consumer;

extracting the loyalty identifier from the single-use payment token; and

updating a record of the consumer associated with the loyalty identifier.

A further feature of the invention provides for the method to include the step of transmitting the single-use payment token to a payment processing server for transaction processing.

Still further features of the invention provide for the method to include the step of extracting single-use payment credentials from the single-use payment token and transmitting the single-use payment credentials to a payment processing server for transaction processing.

Yet further features of the invention provide for the record to be a record of transactions by the consumer associated with the loyalty identifier at the merchant, and wherein the record includes details of products purchased from the merchant by the consumer.

In accordance with a fourth aspect of the invention, there is provided a system for providing payment credentials usable in a transaction, the system including a token processor comprising:

a request receiving component for receiving a request for single-use payment credentials from a communication device of a consumer;

a payment credential component for obtaining or generating single-use payment credentials;

a loyalty component for obtaining or generating a loyalty identifier being uniquely associated with the consumer; and

a transmitting component for transmitting the single-use payment credentials and the loyalty identifier to the communication device as a combined single-use payment token capable of being presented using the communication device.

A further feature of the invention provides for the loyalty identifier to be a unique number which is the same for all requests by the consumer for single-use payment credentials, such that the loyalty identifier is usable by a merchant in updating a record of the consumer.

A still further feature of the invention provides for the loyalty identifier to be a unique number which is the same for all requests by the consumer for single-use payment credentials usable at a specific merchant such that the loyalty identifier is usable by the specific merchant in updating a record of the consumer.

Yet further features of the invention provide for the system to include a plurality of communication devices, each communication device having: a request transmitting component for transmitting a request for single-use payment credentials; a receiving component for receiving the single-use payment credentials and the loyalty identifier as a combined single-use payment token capable of being presented using the communication device; and a token presentation component for presenting the single-use payment token to a payment acceptance device.

A further feature of the invention provides for the request transmitting component to be configured to include a loyalty identifier in the request; and for the loyalty component to be configured to obtain a loyalty identifier included in the request.

A still further feature of the invention provides for the request transmitting component to be configured to include a consumer identifier in the request; and for the loyalty component to be configured to obtain a loyalty identifier by obtaining a consumer identifier included in the request and using the consumer identifier to query a database and obtain a loyalty identifier associated with the consumer identifier.

Yet further features of the invention provide for the system to include a plurality of payment acceptance devices of merchants, each acceptance device having: a receiving component for receiving a single-use payment token being presented by a communication device; an identifier extraction component for extracting a loyalty identifier from the single-use payment token; and an updating component for updating a record associated with the loyalty identifier.

A further feature of the invention provides for each payment acceptance device to further include a transmitting component for transmitting the single-use payment token to a payment processing server for transaction processing.

A still further feature of the invention provides for each payment acceptance device to include a payment credential extracting component for extracting single-use payment credentials from the single-use payment token and for transmitting the single-use payment credentials to a payment processing server for transaction processing.

In accordance with a fifth aspect of the invention, there is provided a computer program product for providing payment credentials usable in a transaction, the computer program product comprising a computer-readable medium having stored computer-readable program code for performing the steps of:

receiving a request for single-use payment credentials from a communication device of a consumer;

obtaining or generating single-use payment credentials;

obtaining or generating a loyalty identifier being uniquely associated with the consumer;

transmitting the single-use payment credentials and the loyalty identifier to the communication device as a combined single-use payment token capable of being presented using the communication device.

A further feature of the invention provides for the computer-readable medium to be a non-transitory computer readable medium.

In accordance with a sixth aspect of the invention, there is provided a single-use token usable in a transaction, the token comprising: single-use payment credentials; and, a loyalty identifier being uniquely associated with a corresponding consumer.

In accordance with another aspect of the invention there is provided a payment acceptance system comprising:

a plurality of mobile communication devices, each of which is associated with a consumer of the system and configured to request and receive a single-use token;

a service processor in communication with the mobile communication devices and configured to assign a loyalty identifier to each consumer;

a token processor in communication with the service processor and mobile communication devices, the token processor configured to receive the loyalty identifier and a request for a single-use token, to generate single-use payment credentials, to encapsulate the single-use payment credentials and loyalty identifier into a single-use token, and to communicate the single-use token to the mobile communication device of the consumer; and,

a payment acceptor in communication with the mobile communication devices, service processor and token processor, the payment acceptor being configured to accept the single-use token as a payment method.

Further features of the invention provide for the service processor to receive coupons from a product distributor and to transmit the coupons to the mobile communication devices of selected consumers for later inclusion into a single-use token.

The invention also provides for a payment acceptance method conducted at a token processor and comprising the steps of:

receiving a request for single-use payment credentials from a mobile communication device of the consumer; receiving a loyalty identifier; generating single-use payment credentials; encapsulating the single-use payment credentials and loyalty identifier into a single-use token; and, communicating the single-use token to the mobile communication device of the consumer for presentation to a payment acceptor of a merchant.

The invention extends to a payment acceptance method for completing a transaction at a merchant, comprising presenting to a merchant a single-use token which includes single-use payment credentials and a static loyalty identifier, scanning the token to extract the single-use payment credentials and static loyalty identifier, identifying a consumer by means of the static loyalty identifier, applying a reward based on a profile of the identified consumer, and processing the transaction using the single-use payment credentials.

Further features of the invention provide for the single-use token to be a two-dimensional barcode, for the two-dimensional barcode to be a Quick Response (QR) code, and for the single-use payment credentials and static loyalty identifier to be stored in predetermined locations of the QR code.

Further features of the invention provide for the QR code to comprise a human readable section, and for the human readable section to be a name or logo.

Further features of the invention provide for the single-use token to include one or more coupons.

### BRIEF DESCRIPTION OF THE DRAWINGS

FIG. 1A shows a block diagram of a single-use token according to embodiments of the invention;

FIG. 1B shows an exemplary single-use token displayed on a mobile communication device according to embodiments of the invention;

FIG. 2 shows a diagram of a system for identifying a consumer in a retail environment according to embodiments of the invention;

FIG. 3 shows a block diagram of the parties involved in various embodiments of the invention;

FIG. 4 shows a step-by-step diagram according to embodiments of the invention;

FIG. 5 shows a step-by-step diagram of a method according to embodiments of the invention;

FIG. 6 is a schematic diagram which illustrates a system for providing payment credentials for use in completing a transaction according to embodiments of the invention;

FIG. 7 is a block diagram which illustrates components of a token processor for providing payment credentials for use in completing a transaction according to embodiments of the invention;

FIG. 8 is a block diagram which illustrates components of a communication device for providing payment credentials for use in completing a transaction according to embodiments of the invention;

FIG. 9 is a block diagram which illustrates components of a payment acceptance device for providing payment credentials for use in completing a transaction according to embodiments of the invention;

FIG. 10 is a swim-lane flow diagram which illustrates an exemplary in-use scenario of a system for providing payment credentials for use in completing a transaction according to embodiments of the invention;

FIG. 11 is a swim-lane flow diagram which illustrates an exemplary in-use scenario of a system for providing payment credentials for use in completing a transaction according to another embodiment of the invention;

FIG. 12 illustrates an example of a computing device in which various aspects of the disclosure may be implemented; and,

FIG. 13 shows a block diagram of a communication device that may be used in embodiments of the disclosure.

### DETAILED DESCRIPTION

Embodiments of the invention intend to simplify loyalty reward mechanisms by providing a single-use token which contains payment credentials and a static consumer loyalty identifier. Embodiments of the invention can additionally be extended to include coupon information in the single-use token. In the specification to be a consumer may be any user, client, customer, etc. of a merchant.

Single-use payment credentials can be provided by a token vendor to a consumer of the system for the purposes of making a payment in a retail environment. As these payment credentials are valid for a single use only, protection of the payment credentials need not be paramount. For instance, the merchant's point-of-sale (POS) terminal may not need to meet payment card industry (PCI) standards for the protection of payment credentials. The payment credentials may be sent to a mobile communication device of the consumer by the token vendor in the form of a single-use token. The token may, for example, be a 2-D barcode, an optical character recognition (OCR) code or data to be communicated from the mobile communication device by near field communication (NFC). The payment credentials may include information such as a bank identification number (BIN), a primary account number (PAN), a card verification value (CVV) number, an expiration date, a cardholder name or a service code and at least some of this information may be valid for a single use only. Having received the single-use token, the consumer can present it to a merchant to complete a payment. There are a variety of ways in which single-use payment credentials can be implemented, one of which is known from the disclosure of Sankolli et al in US patent publication number US 2011/0238473. There are of course other methods of single-use payment credentials described elsewhere and it should be appreciated that the present invention does not rely on any particular implementation of single-use payment credentials and is instead intended to be used in conjunction with a variety of single-use payment credential implementations. As a result, the methods of implementing single-use payment credentials are not described further here.

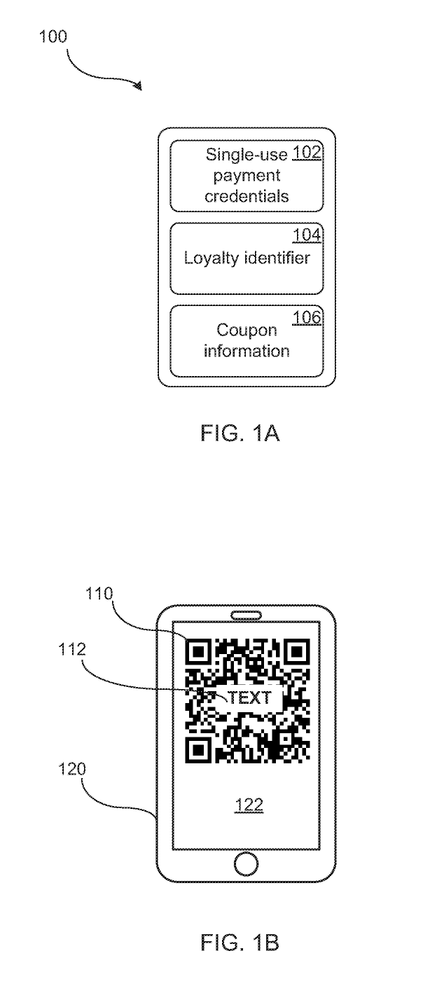

The present invention provides for the extension of single-use tokens (100) to include a consumer loyalty identifier (104) and optionally coupon information (106). FIG. 1A shows a block diagram of such a single-use token (100) which includes single-use payment credentials (102), a consumer loyalty identifier (104) and coupon information (106).

The loyalty identifier (104) may be issued to the consumer by a service provider. The consumer may obtain a loyalty identifier by registering with the service provider. By including the loyalty identifier in the single-use token (100), merchants are able to ‘recognize’ consumers each time they make a purchase. The loyalty identifier may be obtained by the merchant from the single-use token (100) presented by the consumer to the merchant in paying for goods. This allows merchants to reward consumers of the system for loyalty and does not require the presentation of a separate loyalty card. Multiple merchants can each use the same loyalty identifier to associate the same consumer to a loyalty program of each respective merchant.

The single-use token may also contain coupon information (106). A product distributor, for example, may want to incentivize consumers to purchase certain products and may do so by issuing consumers with coupons. The coupons may be valid for a specific product purchased from any number of partnering stores. The coupons may be sent to the consumer for later use. When requesting a single-use token from the token vendor, the consumer can request that the coupon information be included in the single-use token. By presenting the single-use token to the merchant for the payment of products, the consumer can also redeem any relevant coupons.

Embodiments of the invention provide for the single-use token (100) to be either a visual, acoustic or electromagnetic representation of information encoded therein. For example, the single-use token (100) may be a two-dimensional barcode such as a Quick Response (QR) code, an optical character recognition code, an audio stream or near-sound communication audio stream, a near field communication data stream, or a visible light communication data stream.

Embodiments providing for the single-use token (100) to be a visible light communication data stream and may accordingly provide for the payment credentials to be encoded and transmitted via spatial, temporal, or frequency modulation of light. The light may, for example, emanate, from pixels on a display of a mobile communication device to be captured by a merchant payment acceptor, for example a camera of a merchant mobile communication device.

FIG. 1B illustrates a preferred embodiment of the invention in which the single-use token is a QR code (110) which is displayed on a display (122) of a mobile communication device (120). The QR code (110) according to embodiments of the invention may include single-use payment credentials (102), a consumer loyalty identifier (104) and coupon information (106). In addition to the aforementioned information, the QR code (110) may comprise human-readable information (112) which may, for example, be the name or logo of a service provider, issuing bank or the like.

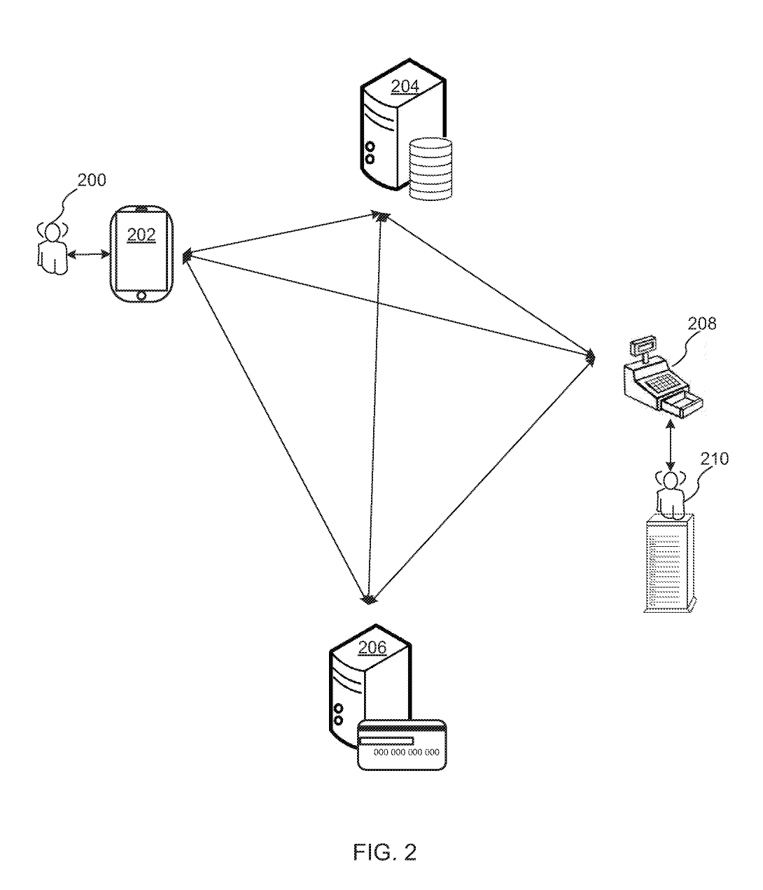

FIG. 2 shows a system according to embodiments of the invention. The figure shows a mobile communication device (202), associated with a consumer (200) and having been configured to request and receive a single-use token (100). Also shown in FIG. 2 is a service processor (204) which is in communication with the mobile communication device (202) and is configured to assign a loyalty identifier (104) to each consumer. The loyalty identifier may be stored in a digital memory of the mobile communication device. The figure shows a token processor (206) which is in communication with the service processor (204) and mobile communication device (202). The token processor is configured to receive the loyalty identifier (104) and a request for a single-use token (100). Responsive to receiving such a request, the token processor is configured to generate single-use payment credentials (102) specific to the consumer (200) and to encapsulate the single-use payment credentials (102) and loyalty identifier (104) into a single-use token (100). The token processor is configured to then communicate the single-use token (100) to the mobile communication device (202) of the consumer (200). The figure also shows a payment acceptor (208) of a merchant which may be in communication with the mobile communication device (202), the service processor (204) and the token processor (206). The payment acceptor (208) is configured to accept the single-use payment token (100) as a payment method and to use information contained therein to process and complete a payment. The payment acceptor (208) is further able to extract the loyalty identifier (104) from the token (100) so as to identify the consumer (200) and associate him or her with a consumer profile stored in a consumer database (210).

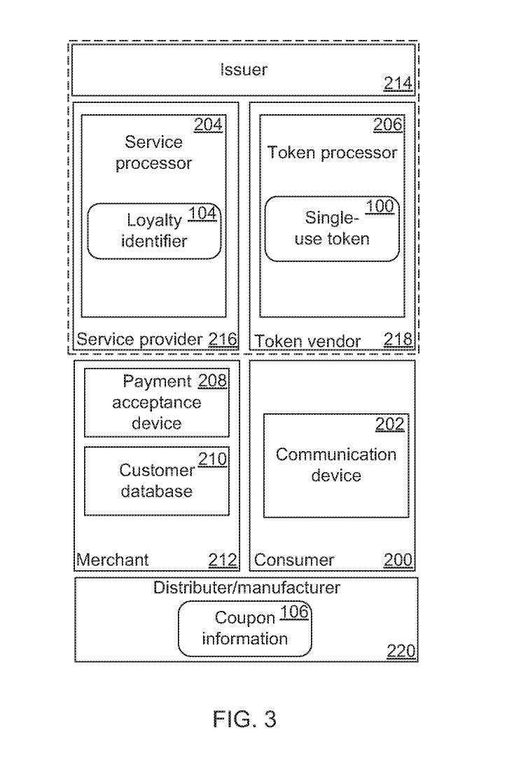

FIG. 3 is a block diagram showing the various entities of the system and the components associated with each entity. In an exemplary case, the entities include a consumer (200), a merchant (212), a service provider (216), a token vendor (218), an issuer (214) and possibly a product distributor or manufacturer (220). Of course it should be appreciated that in a practical implementation of such a system, there may be one or a plurality of each of these entities.

The service provider (216) maintains a service processor (204) which may be configured to assign a loyalty identifier (104) to a consumer of the system (200) upon registration by that consumer (200) with the service provider (216).

Each consumer (200) of the system has their own mobile communication device (202) which may be configured to request single-use payment credentials (102) and may also be used to present the single-use payment credentials (102), which may be encapsulated in a single-use token (100), to the merchant so as to complete a transaction. The mobile communication device (202) may also have a loyalty identifier (104) associated with it and stored therein.

The token vendor (218) may maintain a token processor (206) which is configured to generate single-use payment credentials (102) and encapsulate these payment credentials (102) into a single-use token (100). The single-use token (100) can be communicated to the mobile communication device (202) of the consumer (200) for presentation to the payment acceptor (208) of merchant (212) for the purposes of completing a transaction. In this manner products or goods may be purchased from the merchant. Embodiments of the invention also provide for the token processor (206) to receive the loyalty identifier (104) and to include the loyalty identifier (104) in the single-use token (100) along with the single-use payment credentials (102). The token processor may also include coupon information (106) in the single-use token (100).

The issuer (214) shown in the figure is the issuer of the consumer (200) and may, for example, be a financial institution, a bank, a mobile money banking institution or the like. Embodiments of the invention provide for the issuer (214), service provider (216) and token vendor (218) to be a part of the same entity, in which case the functionality of, for instance, the token processor (206) and service processor (204) may be shared by a common processor.

A product distributor or manufacturer (220) may also be an entity of the system. The distributor or manufacturer (220) may want to incentivize a consumer to purchase a particular product. This may be done by issuing coupons. Embodiments of the invention provide for the distributor or manufacturer (220) to instruct the service provider (216) to issue a coupon for a particular product to a consumer of the system (200). In doing so, the service processor (204) may communicate the coupon information (106) received from the product distributor or manufacturer (220) to the mobile communication device (202) of the consumer (200). The consumer (200) can then indicate that the coupon is to be redeemed, and thus responsive to a request from the consumer (200) for a single-use payment token (100), the token processor (206) may include the coupon information (106) in the single-use token (100) along with the single-use payment credentials (102) and loyalty identifier (104).

A merchant (212) of the system may have a payment acceptor (208) and consumer database (210). The payment acceptor (208) may be configured to receive a single-use token (100) as a payment method and may also extract a loyalty identifier (104) or coupon information (106) if present. The consumer database (210) may then receive the loyalty identifier (104) from the payment acceptor (208) and use it to associate the consumer (200) making the payment with a consumer profile stored on the consumer database (210). In doing so, the merchant can credit the consumer's consumer profile with loyalty points or the like.

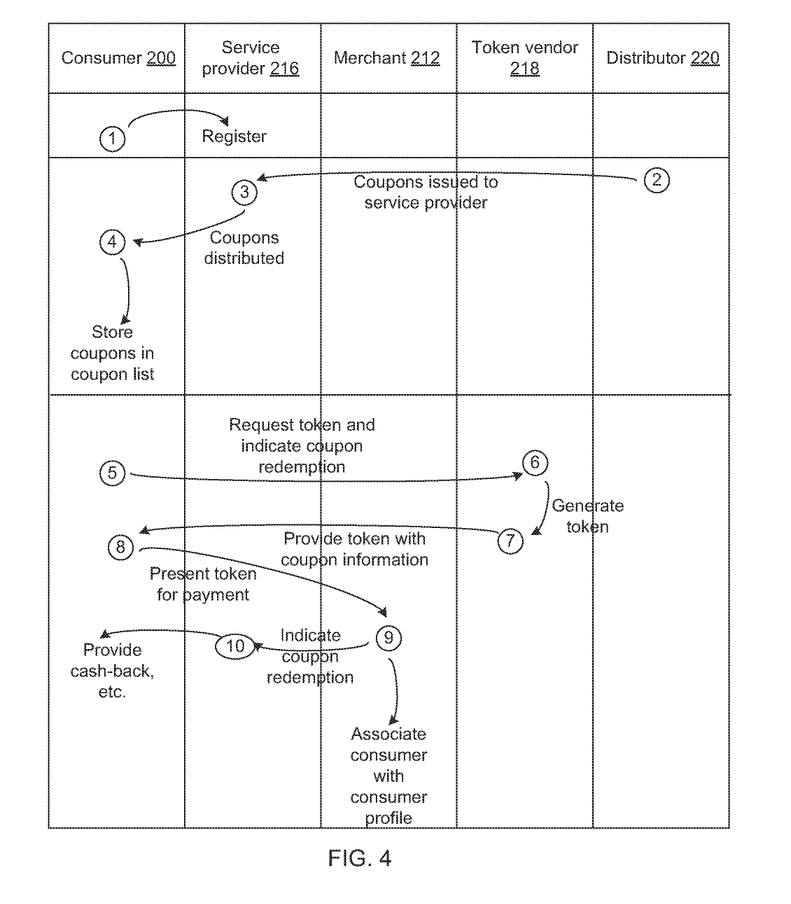

An exemplary scenario of the system in use in a retail environment is described below with reference to FIG. 4. In a first, initialization step (1), the consumer (200) registers with the service provider (216) and receives a static loyalty identifier (104). The consumer is already subscribed to the services of the token vendor (218) in that he or she is already operable to request and make use of single-use payment credentials (102) from the token vendor (218) for the purposes of completing a transaction.

At some later point in time, a distributor (220) may issue coupons to the service provider (216) in a distribution step (2). The distributor (220) may instruct the service provider to issue the coupons to consumers who, for example, have a particular spend history or who frequent certain stores. In a next step (3), the service provider (216) may distribute the coupons to relevant consumers of the system (200). This distribution may be in the form of an SMS, email or other electronic communication containing the coupon information (106) from the service processor (216) to the consumer's mobile communication device (202). In a next step (4), the consumer (200) may decide to store the received coupon and the coupon information (106) is then stored in a digital memory of the mobile communication device (202) for later use. Alternatively, the coupons may be distributed in printed media, for example, magazines or newspapers, such that consumers can capture (e.g. by scanning QR or OCR code with a mobile communication device (202)), register the captured coupons with the service provider (216) and store the captured coupons in a digital memory of the mobile communication device (202) for later use.

The steps to follow may be performed each time a consumer (200) in a retail environment wishes to make a purchase. In a first purchasing step (5), the consumer (200), wishing to pay for products, requests a single-use token (100) from the token vendor (218). In doing so, the consumer (200) may also indicate to the token vendor (218) a wish to redeem at least one coupon which the consumer has stored in a digital memory of his or her mobile communication device (202). In a next step (6) conducted at the token vendor (218), the token processor (206) then generates single-use payment credentials (102) and encapsulates these payment credentials (102) into a single-use token (100) along with the consumer's loyalty identifier (104) and the relevant coupon information (106). The token vendor (218) may receive the loyalty identifier (104) and coupon information (106) from the consumer (200), or the token vendor (218) may request this information from the service provider (216). In a subsequent step (7), the single-use token (100) containing the payment credentials (102), loyalty identifier (104) and coupon information (106) is then communicated to mobile communication device (202) of the consumer (200).

Having received the single-use token (100), the consumer (200), in a next step (8), presents the single-use token (100) to the merchant (212) who uses a payment acceptor (208) to accept and process the single-use token (100) so as to complete a transaction. The payment acceptor (208) may, for example, extract the payment credentials (102), loyalty identifier (104) and coupon information (106). The payment is processed according to methods prescribed for single-use payment credentials so as to complete the transaction. In addition to this, the payment acceptor (208) may use the loyalty identifier (104) to associate the consumer (200) with a consumer profile stored in a consumer database (210) and may then award loyalty points to the consumer, and stored in association with the consumer's consumer profile, according to a retailer loyalty program. Furthermore, the payment acceptor (208) may cross-check the coupon information (106) against products purchased by the consumer in the present transaction so as to ensure that a relevant product in respect of a redeemed coupon is purchased. The payment acceptor (208) may then indicate to the service processor (204) of the service provider (216) that the coupon has been redeemed by the consumer (200). The service provider (216) may then acknowledge the redemption of the coupon in a final step (10) and may provide the consumer (200) with a reward according to the instructions of the distributor (220). The reward may, for example, be a cash-back.

In another embodiment of the invention, the single-use token may be a numerical code that does not contain payment credentials, a loyalty identifier or coupon information. In this embodiment, a consumer requests a single-use token from a token vendor. The token vendor provides the consumer with a numerical single-use token and in turn provides a service provider with single-use payment credentials and a loyalty identifier. In paying for a product in a retail environment, the consumer presents the merchant with the numerical single-use token. The merchant then provides the service provider with the numerical code contained within the numerical single-use token. The service provider responds by providing the merchant with the payment credentials and the loyalty identifier and optionally coupon information. The merchant can then finalize the purchase using the payment credentials received from the service provider and can also credit a loyalty account of the consumer accordingly.

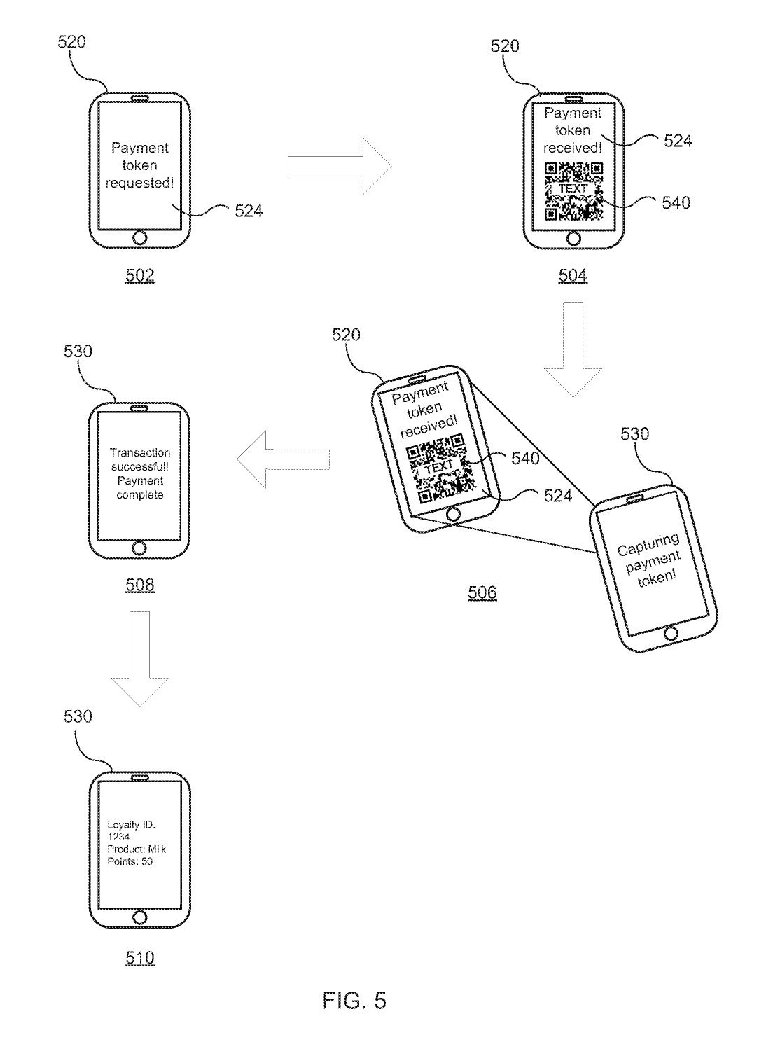

Embodiments of the invention provide for a method for completing a transaction at a merchant, which will be described below with reference to FIG. 5. The method provides a mobile communication device of a consumer, e.g. a consumer's mobile phone (520) and a merchant payment acceptor, which in this case may be a mobile phone (530) of the merchant. Accordingly, a consumer purchasing a product in a retail environment may implement the following steps of the method so as to complete a transaction.

In a first step (502), the consumer requests a single-use payment token from his or her issuer using his or her mobile phone (520). In this example, the consumer's issuer is a mobile money operator which provides the services of the issuer (214), the service provider (216) and the token vendor (218) according to the foregoing description. Responsive to the consumer's request, relevant processors of the issuer generate single-use payment credentials (102), for example comprising a single-use primary account number (PAN), a static bank identification number (BIN), an expiration date (for example the same day on which the credentials are requested). The relevant processors may include a service processor (204) and a token processor (206). The relevant processors of the issuer then store a copy of these single-use payment credentials (102) in a database in association with, for example, a financial account of the consumer. The relevant processors then encapsulate these single-use payment credentials (102) and a loyalty identifier (104) having been assigned to the consumer into a single-use token, which in this case is a QR code (540), and communicates the QR code (540) to the mobile phone (520) of the consumer.

In a next step (504), the consumer's mobile phone (520) receives the QR code (540) and displays it visually on a display (524) of the mobile phone (520). The consumer then presents his or her mobile phone (520) to the merchant, who, in a following step (506), captures the QR code (540) being displayed on the display (524) of the consumer's mobile phone (520) with a camera of the merchant's mobile phone (530). The QR code (540) is decoded by the merchant's mobile phone (530) to extract the single-use payment credentials (102) and the loyalty identifier (104).

In a following step (508), the merchant's mobile phone (530) uses the extracted single-use payment credentials (102) to process and complete the transaction. The merchant's mobile phone (530) also uses the extracted loyalty identifier (104), in a next step (510), to associate the consumer to a consumer profile which may be stored in a consumer database on a server computer maintained by the merchant. Having used the loyalty identifier (104) to identify the consumer, the merchant may then assign loyalty points to the consumer based on the product purchased, the transaction value or the like. Similarly, the merchant is able to maintain a record of products purchased by individual consumers, the average spend of individual consumers or the like.

The steps implemented by a consumer at a merchant in the above example may similarly be implemented at another merchant, the other merchant using the same loyalty identifier (104) to associate the consumer to consumer profile of the other merchant's loyalty program.

Embodiments of the forgoing descriptions further provide for the functions provided by the service provider, token vendor and issuer to be provided by the same entity. For instance, an issuer may be able to provide single-use payment credentials responsive to a request by a consumer, thus additionally offering the services of the token vendor. The issuer may also provide a loyalty identifier with the single-use payment credentials, by doing so additionally offering the services of the service provider. In this embodiment, the mobile communication device of the consumer need only be in communication with a token and service processor of the issuer as well as a payment acceptor of the merchant.

Alternatively, the service processor may be a mobile money general processor and the token processor may be maintained by a mobile money platform.

Embodiments of the invention provide for the service processor to be a server computer which may be in communication with the token processor, mobile communication devices and payment acceptor. The service processor may be configured to receive a request for a loyalty identifier from a mobile communication device. Responsive to this request, the service processor may be configured to generate a loyalty identifier for the consumer corresponding to the mobile communication device from which the request originated. The service processor may be configured to communicate this loyalty identifier to the mobile communication device and to store it in a database. Furthermore, the service processor may be configured to provide the token processor, the mobile communication device or the payment acceptor with the loyalty identifier of the consumer responsive to a request, which may originate from the token processor, mobile communication device or payment acceptor.

In addition to this, the service processor may also be configured to receive coupons from a product distributor or manufacturer and to distribute these coupons to consumers of the system. The service processor may further be configured to store coupon information for a consumer having accepted a coupon and for the coupon information to be stored in association with the loyalty identifier of that consumer. The token processor may also be configured to store receive confirmation of redemption of a coupon, and to enact an appropriate credit to a financial account linked to the consumer having redeemed the coupon, the appropriate credit having been determined by the product distributor or manufacturer to whom the coupon relates. The coupon information may include coupons to be issued to the consumer, coupons which the consumer has accepted or coupons which the consumer has redeemed.

Embodiments of the invention provide for the token processor to be a server computer configured to generate single-use payment credentials and to encapsulate them in a single-use token. Furthermore, the token processor may be configured to include a loyalty identifier and possibly coupon information in the single-use token. The token processor may be operated by a token vendor, an issuer or the service provider.

Embodiments of the invention provide for the coupon information to include a product identifier which can be compared to purchased products by the merchant so as to check for redeemed coupons, a unique coupon identifier such that the coupon lifecycle, from distribution to acceptance by the consumer to redemption at a merchant can be monitored.

Embodiments of the invention provide for the single-use token to contain single-use payment credentials and a consumer loyalty identifier; or to contain single-use payment credentials, coupon information and a consumer loyalty identifier. Embodiments of the invention also provide for a single service provider to issue a consumer loyalty identifier and, optionally, coupons to the consumer. The coupons, in turn, may be issued to the service provider by a distributor or manufacturer of the product.

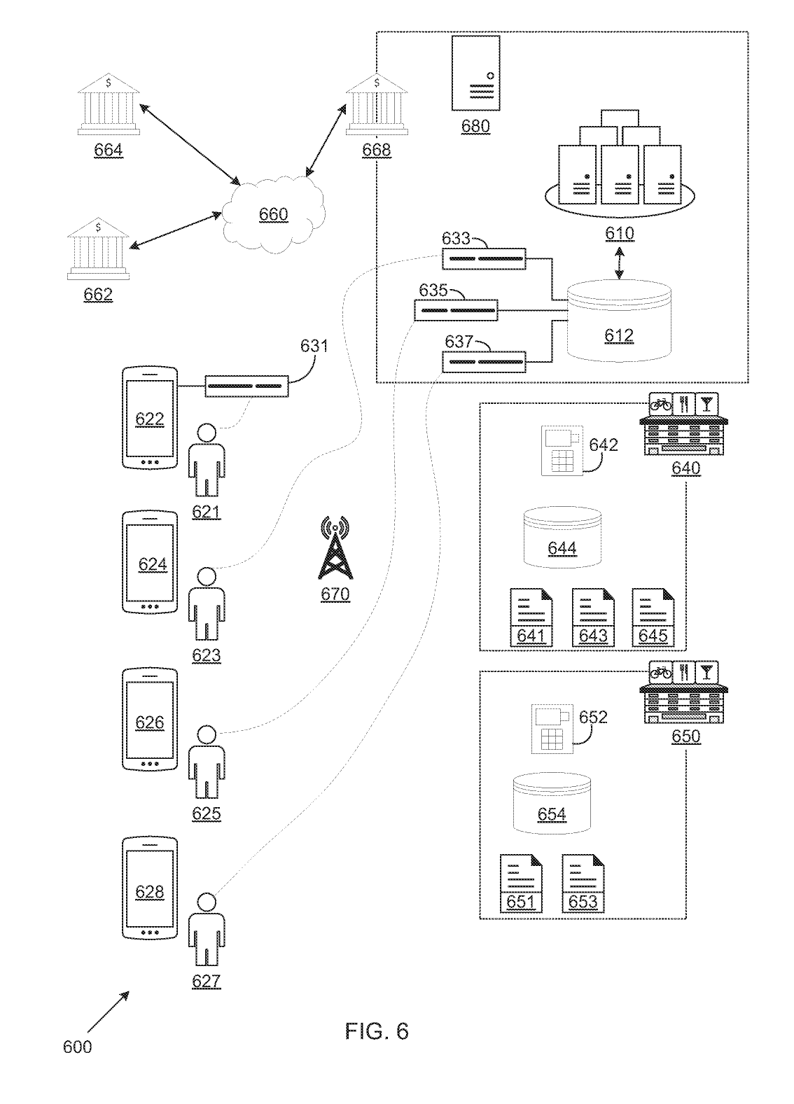

FIG. 6 is a schematic diagram which illustrates a system (600) for providing payment credentials for use in completing a transaction according to embodiments of the invention. The system (600) includes a token processor (610), a plurality of communication devices (622, 624, 626 and 628) and a plurality of payment acceptance devices (642, 652). Data communication between, for example the token processor (610) and the communication devices (622, 624, 626 and 628), the payment acceptance devices (642, 652) and the token processor (610) or the like may be provided by a communication network (670) which may include wired and wireless data communication networks.

The token processor (610) may be any appropriate server computer or distributed server computer and may be operated by a financial services provider (668) or may be independently operated. The token processor (610) may include a database (612) in which a plurality of loyalty identifiers (633, 635, 637) may be stored in relation to a consumer identifier.

The token processor (610) may be configured to receive requests for single-use payment credentials or single-use payment tokens from any of the mobile communication devices (622, 624, 626 and 628). Each request may include a consumer identifier of a consumer (e.g. 621) associated with the communication device (e.g. 622) from which the request is transmitted. The consumer identifier may, for example, be a communication address of the consumer's communication device such as a mobile subscriber integrated services digital network (MSISDN) number, an international mobile station equipment identity (IMEI) number, an international mobile subscriber identity (IMSI) or the like.

The token processor (610) may then be configured to obtain or generate single-use payment credentials for the consumer (621). The token processor may, for example, generate single-use payment credentials which are usable against a financial account of the consumer (621), or the token processor (610) may obtain single-use payment credentials from an issuing financial services provider (e.g. 662, 664 or 668) of the consumer (621).

While in some embodiments, the token processor (610) is configured to transmit only single-use payment credentials to a requesting communication device, in other embodiments, the token processor (610) is further configured to obtain or generate a loyalty identifier which is uniquely associated with the consumer (621) corresponding to the communication device (622) from which the request originated. In some embodiments of the invention, the loyalty identifier (e.g. 631) may be stored in a digital memory of the consumer's communication device and may thus be included in the request. The token processor (610) may thus be configured to obtain the loyalty identifier from the request. In other embodiments, such as for the case of another consumer (623), the loyalty identifier (e.g. 633) may be stored in a database (612) of the token processor (610). The token processor (610) may then be configured to obtain the loyalty identifier (633) by obtaining a consumer identifier included in the request and using the consumer identifier to query the database (612) and obtain the loyalty identifier (633) associated with the consumer identifier.

The token processor (610) may be further configured to transmit the single-use payment credentials and the loyalty identifier (631 or 633) to the communication device (622 or 624) as a combined single-use payment token capable of being presented using the communication device.

The combined single-use payment token one or more of the group of: a quick response (QR) code; an audio stream or near-sound communication audio stream; an optical character recognition code; a near field communication data stream; or a visible light communication data stream.

In other embodiments of the invention, such as where a loyalty identifier (e.g. 631) is stored in a digital memory of a communication device (622), the token processor (610) may transmit only the single-use payment credentials to the communication device (622) for combination with the loyalty identifier (631) into a single-use payment token thereat.

The loyalty identifier (e.g. 633) according to embodiments of the invention is a unique number (which may be a binary, decimal, hexadecimal number or the like) and is the same for all requests by the consumer (623) for single-use payment tokens, such that the loyalty identifier is usable by a merchant (640 or 650) in updating a record of the consumer. In some embodiments of the invention, different merchants (640, 650) may provide a consumer with their own merchant specific loyalty identifier such that a consumer (e.g. 626) may end up with multiple loyalty identifiers for each merchant. As such, some embodiments of the invention provide for the loyalty identifier to be the same for all requests by the consumer for single-use payment credentials or single-use payment tokens usable at a specific merchant such that the loyalty identifier is usable by the specific merchant in updating a record of the consumer. A merchant may thus be able to ‘recognize’ a consumer that has previously transacted with the merchant. In some embodiments of the invention, the service processor (680) may be responsible for assigning loyalty identifiers to consumers at, for example, registration.

In some embodiments of the invention, the token processor (610) may be configured to obtain coupon information corresponding to one or more coupons. The coupon information may be obtained from a merchant (640, 650), from a service processor (680) or from a communication device (622, 624, 626, 628). The token processor (610) may thus be configured to include the coupon information in the combined single-use payment token.

The communication devices (622, 624, 626 and 628) may be any appropriate device capable of communication. The communication devices may be mobile communication devices such as smart phones, feature phones, cell phones, tablet computers, personal digital assistants (PDAs) or the like. Each communication device (622, 624, 626 and 628) may be operated by a respective consumer (621, 623, 625 and 627) and may be configured to transmit a request for single-use payment credentials or a single-use payment token to the token processor (610). In some embodiments of the invention, the request may include either a consumer identifier or a loyalty identifier of the consumer stored in a digital memory of the communication device.

Each communication device (622, 624, 626 and 628) may be configured to receive the single-use payment credentials and the loyalty identifier as a combined single-use payment token capable of being presented using the communication device.

In some embodiments of the invention, each communication device (622, 624, 626 and 628) may be configured to receive the combined single-use payment token from the token processor (610), while in other embodiments, communication device (e.g. 622) may receive single-use payment credentials only from the token processor and may be configured to obtain the loyalty identifier (631) being uniquely associated with a corresponding consumer (622) and to locally combine the single-use payment credentials and loyalty identifier (631) into a combined single-use payment token.

Each communication device (622, 624, 626 and 628) may be further configured to present the single-use payment token to a payment acceptance device (642, 652).

The payment acceptance devices (which may also be referred to as payment acceptors) (642, 652) may be maintained by respective merchants (640, 650). In some embodiments, a single merchant may have a plurality of payment acceptance devices. The payment acceptance devices (642, 652) may be any appropriate devices which may include an optical input, an audio input, an electromagnetic input, or the like. Exemplary payment acceptance devices (642, 652) include smartphones, appropriately configured point-of-sales devices, tablet computers or the like. Each payment acceptance device (642, 652) may be configured to receive a single-use payment token being presented by a communication device (622, 624, 626, 628).

Receiving a single-use payment token may include optically receiving the single-use payment token for example using a camera. In other embodiments, the single-use payment token may be received using a microphone, electromagnetic transducer, such as a near field communication (NFC) or radio frequency identification (RFID) antenna or the like.

Each payment acceptance device (642, 652) may further be configured to extract a loyalty identifier from the single-use payment token and to update a record of a consumer associated with the loyalty identifier.

Embodiments of the invention provide the payment acceptance devices (642, 652) to be further configured to transmit the single-use payment token to a payment processing server for transaction processing. In some embodiments, the payment acceptance devices (642, 652) may be configured to extract single-use payment credentials from the single-use token and to transmit the single-use payment credentials to a payment processing server for transaction processing. The payment processing server may be operated by a financial services provider (662, 664, 668) being an issuer or acquirer as may be required or by a payment processing network (660).

The payment acceptance devices (642, 652) may be configured to maintain a plurality of records (641, 643, 645, 651, 653) in a database (644, 654) of respective merchants (640, 650). Each record (e.g. 641) may be associated in the database (644) of a merchant (640) with a loyalty identifier (e.g. 631) of a consumer (621) and may be a record of transactions by the consumer (621) associated with the loyalty identifier (631) at the merchant (640). For example, the record (641) may include details of products purchased from the merchant (640) by the consumer (621) such as a stock keeping unit (SKU) or the like.

Thus, each time the consumer (621) returns to the merchant (640) and uses a single-use payment token as a payment method, the merchant (640) may be able to recognize the consumer (621) and may be able to update the consumer's record to reflect his or her latest purchases. As a result, merchants (640, 650) may be able to maintain a consumer purchase history and may be able to interpret the history for the purposes of, for example, marketing or the like. Furthermore, merchants (640, 650) need only to be able to extract loyalty identifiers (631, 633, 635, 637) from single-use payment tokens. The merchants (640, 650) are not required to integrate with a loyalty system or a central loyalty processor thus requiring minimal interoperability on the part of merchants. The merchants may use the loyalty identifiers (631, 633, 635, 637) within their own systems as they may see appropriate.

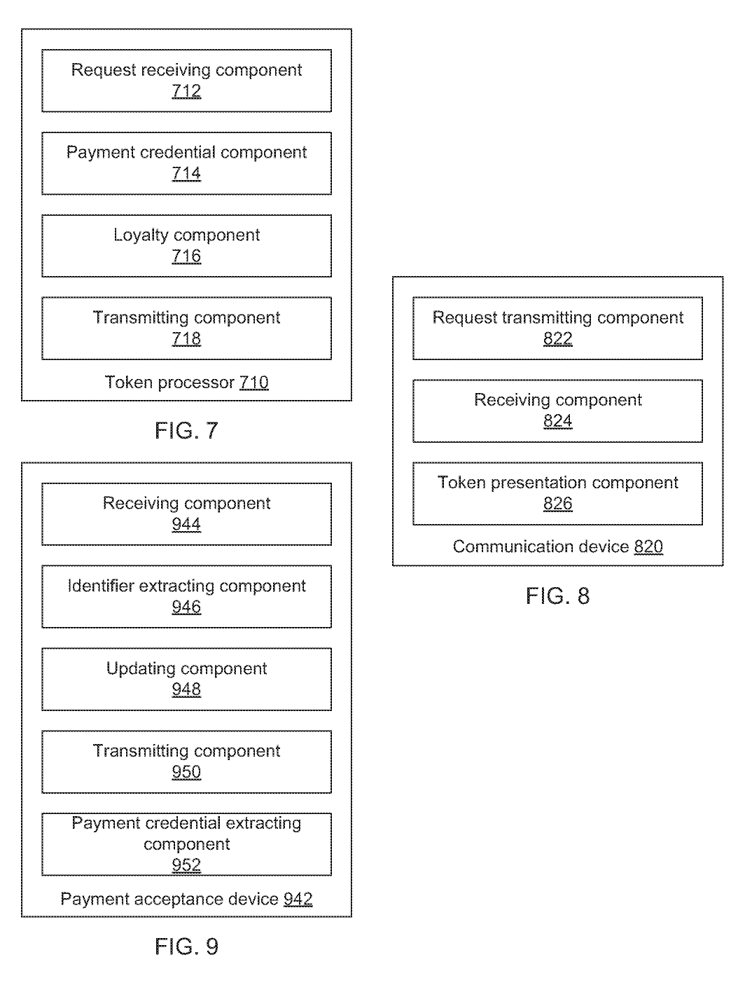

FIG. 7 is a block diagram which illustrates components of a token processor (710) for providing payment credentials for use in completing a transaction according to embodiments of the invention.

The token processor (710) includes a request receiving component (712) for receiving a request for single-use payment credentials or a single-use payment token from a communication device and a payment credential component (714) for obtaining or generating single-use payment credentials. The token processor (710) also includes a loyalty component (716) for obtaining or generating a loyalty identifier being uniquely associated with a corresponding consumer and a transmitting component (718) for transmitting the single-use payment credentials and the loyalty identifier to the communication device as a combined single-use payment token capable of being presented using the communication device.

In some embodiments of the invention, the loyalty component (716) may be configured to obtain a loyalty identifier included in the request. In other embodiments, the loyalty component (716) may be configured to obtain a loyalty identifier by obtaining a consumer identifier included in the request and using the consumer identifier to query a database and obtain a loyalty identifier associated with the consumer identifier.

FIG. 8 is a block diagram which illustrates components of a communication device (820) for providing payment credentials for use in completing a transaction according to embodiments of the invention.

The communication device (820) may include a request transmitting component (822) for transmitting a request for single-use payment credentials or a single-use payment token to the token processor and a receiving component (824) for receiving the single-use payment credentials and the loyalty identifier as a combined single-use payment token capable of being presented using the communication device. The communication device (820) may further include a token presentation component (826) for presenting the single-use payment token to a payment acceptance device.

Embodiments provide for the request transmitting component (822) to be configured to include a loyalty identifier in the request while in other embodiments, the request transmitting component (822) is configured to include a consumer identifier in the request. It may also be the case that both a loyalty identifier and a consumer identifier are included in the request.

FIG. 9 is a block diagram which illustrates components of a payment acceptance device (942) for providing payment credentials for use in completing a transaction according to embodiments of the invention.

The payment acceptance device (942) includes a receiving component (944) for receiving a single-use token being presented by a communication device and an identifier extracting component (946) for extracting a loyalty identifier from the single-use token. The payment acceptance device (942) may also include an updating component (948) for updating a record associated with the loyalty identifier.

The payment acceptance device (942) may further include a token transmitting component (950) for transmitting the single-use token to a payment processing server for transaction processing. In some embodiments the payment acceptance device (942) may include a payment credential extracting component (952) for extracting single-use payment credentials from the single-use token and to transmit the single-use payment credentials to a payment processing server for transaction processing.

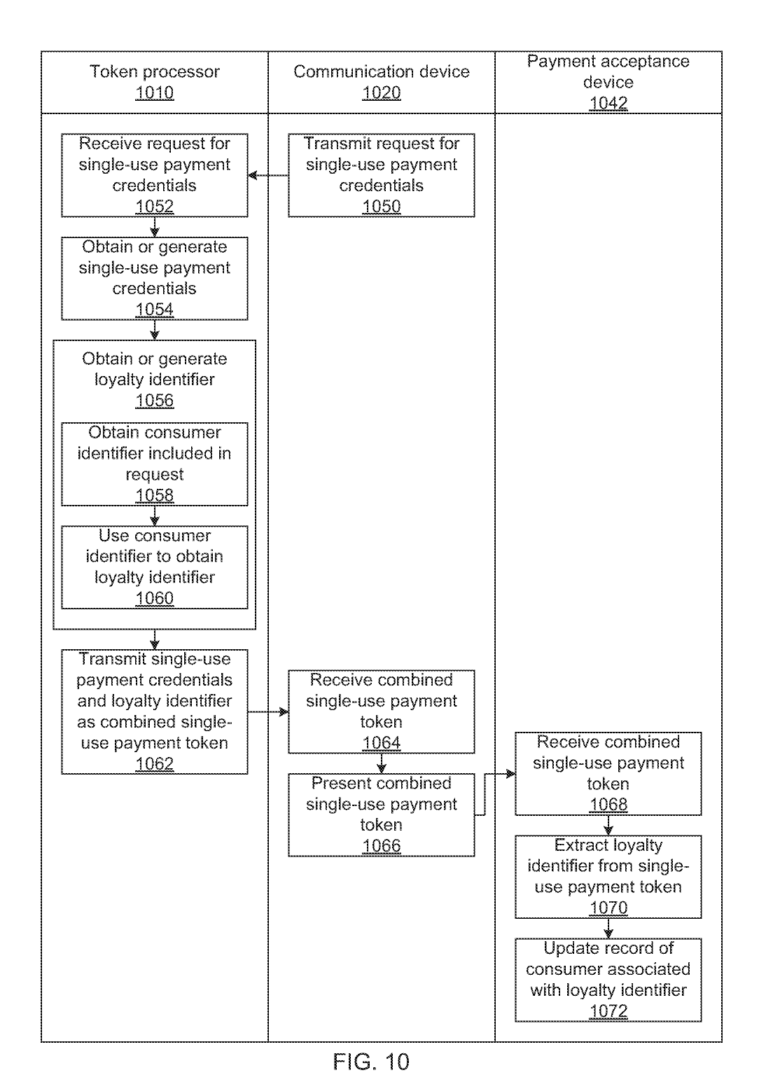

FIG. 10 is a swim-lane flow diagram which illustrates an exemplary in-use scenario of a system for providing payment credentials for use in completing a transaction according to embodiments of the invention. The respective swim-lanes delimit steps conducted by respective entities or devices. In this manner, methods conducted at a communication device (1020), a token processor (1010) and a payment acceptance device (1042) are illustrated.

At a first step (1050), a consumer, wishing to purchase a product from a merchant may use his or her communication device (1020) to transmit a request for single-use payment credentials to the token processor (1010). In the illustrated embodiment of the invention, the request for single-use payment credentials includes a consumer identifier while in other embodiments of the invention, the request for single-use payment credentials may include a loyalty identifier in the request. The loyalty identifier may be the same for all requests by the consumer for single-use payment credentials or tokens such that the loyalty identifier is usable by a merchant in updating a record of the consumer. In other embodiments, the loyalty identifier may be the same for all requests by the consumer for single-use payment credentials or tokens usable at a specific merchant such that the loyalty identifier is usable by the specific merchant in updating a record of the consumer. For example, payment credentials may be requested for use at a specific merchant being Bob's Fries Outlets, responsive to which a loyalty identifier usable at that specific merchant is included with the single-use payment credentials in a single-use payment token.

The token processor (1010), at a next step (1052), receives the request for single-use payment credentials from the communication device (1020). In a following step (1054), the token processor (1010) may either obtain single-use payment credentials from an issuing financial institution associated with the consumer or may generate single-use payment credentials usable against a financial account of the consumer. The token processor may then obtain or generate a loyalty identifier which is uniquely associated with the corresponding consumer in a next step (1056).

In some embodiments of the invention, obtaining or generating a loyalty identifier being uniquely associated with the consumer may include obtaining a loyalty identifier included in the request. Furthermore, in the case of a first-time consumer, the loyalty identifier may be generated and assigned to the consumer upon such a request. In the illustrated embodiment, however, the step (1056) of obtaining or generating a loyalty identifier being uniquely associated with the consumer includes a step (1058) of obtaining a consumer identifier included in the request and a following step (1060) of using the consumer identifier to query a database and obtain a loyalty identifier associated with the consumer identifier.

In a following step (1062), the token processor (1010) transmits the single-use payment credentials and the loyalty identifier to the communication device (1020) as a combined single-use payment token capable of being presented using the communication device (1020). The step (1062) of transmitting the single-use payment credentials and the loyalty identifier to the communication device as a combined single-use payment token may include encoding the single-use payment credentials and the loyalty identifier into one or more of the group of: a quick response (QR) code; an audio stream or near-sound communication audio stream; an optical character recognition code; a near field communication data stream; or a visible light communication data stream.

In some embodiments of the invention, the token processor (1010) may obtain coupon information corresponding to one or more coupons and may include the coupon information with the single-use payment credentials and the loyalty identifier transmitted to the communication device (1020) as a combined single-use payment token.

In a following step (1064), the communication device (1020) receives the single-use payment credentials which, in the illustrated embodiment, includes receiving single-use payment credentials and a loyalty identifier as a combined single-use payment token from the token processor (1020).

In a next step (1066), the single-use payment credentials and the loyalty identifier are presented to the payment acceptance device (1042) as a combined single-use payment token.

The payment acceptance device (1042) then, in a following step (1068), receives the single-use payment credentials and a loyalty identifier as a single-use payment token. In a next step (1070), the payment acceptance device (1042) extracts a loyalty identifier from the single-use payment token and in a following step (1072) updates a record of the consumer associated with the loyalty identifier.

The record may be a record of transactions by the consumer associated with the loyalty identifier at the merchant and may include details of products purchased from the merchant by the consumer.

In some embodiments of the invention, the payment acceptance device (1042) may transmit the single-use payment token to a payment processing server for transaction processing. In other embodiments, the payment acceptance device (1042) may extract single-use payment credentials from the single-use token and transmit the single-use payment credentials to a payment processing server for transaction processing.

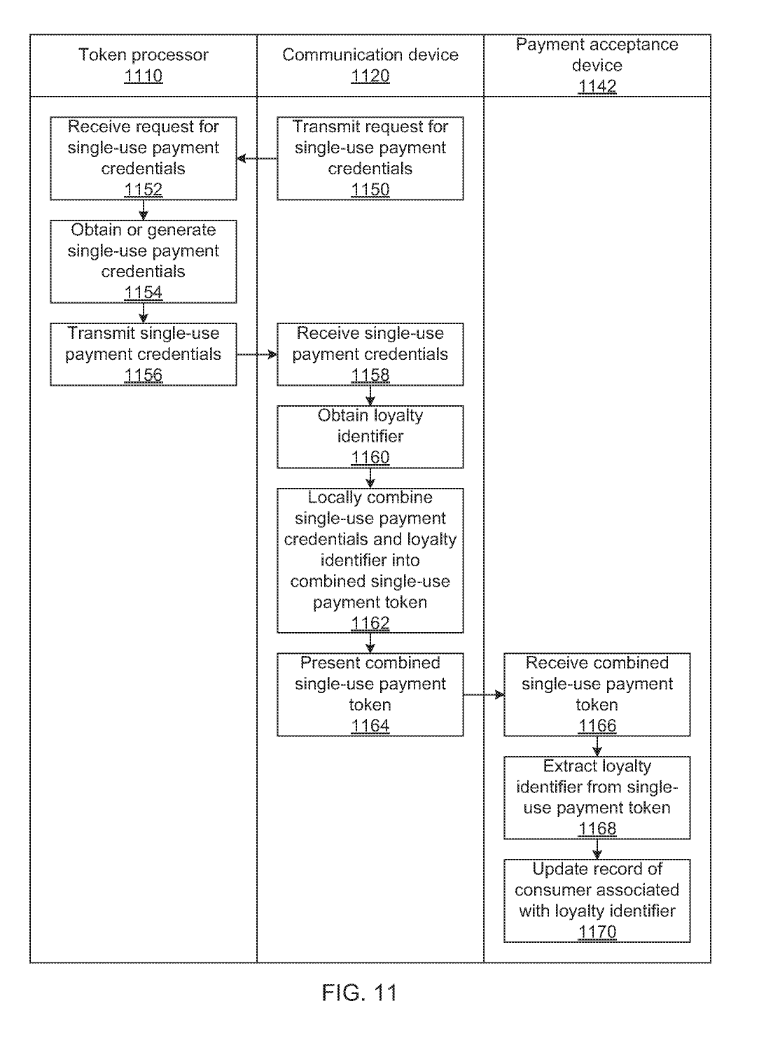

FIG. 11 is a swim-lane flow diagram which illustrates an exemplary in-use scenario of a system for providing payment credentials for use in completing a transaction according to another embodiment of the invention. The respective swim-lanes delimit steps conducted by respective entities or devices. In this manner, methods conducted at a communication device (1120), a token processor (1110) and a payment acceptance device (1142) are illustrated.

At a first step (1150), a consumer, wishing to purchase a product from a merchant may use his or her communication device (1120) to transmit a request for single-use payment credentials to the token processor (1110). In the illustrated embodiment of the invention, the request for single-use payment credentials includes a consumer identifier.

The token processor (1110), at a next step (1152), receives the request for single-use payment credentials from the communication device (1120). In a following step (1154), the token processor (1010) obtains or generates single-use payment credentials. In the embodiment illustrated in FIG. 11, the loyalty identifier is not transmitted from the communication device (1120) to the token processor (1110), nor does the token processor (1110) obtain or generate the loyalty identifier.

Instead, in a next step (1156), the token processor (1110) transmits the single-use payment credentials to the communication device (1120).

In a following step (1158), the communication device (1120) receives the single-use payment credentials and, in a following step (1160), obtains a loyalty identifier being uniquely associated with the corresponding consumer from a digital memory of the communication device (1120). The communication device (1120) then, in a next step (1162) locally combines the single-use payment credentials and loyalty identifier into a combined single-use payment token which is capable of being presented using the communication device (1120). Locally combining the single-use payment credentials and loyalty identifier into a combined single-use payment token may include encoding the single-use payment credentials and the loyalty identifier into one or more of the group of: a quick response (QR) code; an audio stream or near-sound communication audio stream; an optical character recognition code; a near field communication data stream; or a visible light communication data stream.

In a next step (1164), the single-use payment credentials and the loyalty identifier are presented to the payment acceptance device (1142) as a combined single-use payment token.

The payment acceptance device (1142) then, in a following step (1166), receives the single-use payment credentials and a loyalty identifier as a single-use payment token. In a next step (1168), the payment acceptance device (1142) extracts a loyalty identifier from the single-use payment token and in a following step (1170) updates a record of the consumer associated with the loyalty identifier.

As has been previously described, in some embodiments of the invention, the payment acceptance device (1142) may transmit the single-use payment token to a payment processing server for transaction processing. In other embodiments, the payment acceptance device (1142) may extract single-use payment credentials from the single-use token and transmit the single-use payment credentials to a payment processing server for transaction processing.

Embodiments of the invention thus describe a systems and methods for providing payment credentials usable in a transaction. Systems and methods of the invention provide a loyalty identifier which may a ‘global’ identifier specific to a consumer or consumer and usable by that consumer or consumer at any participating merchant. A participating merchant need not integrate with disparate systems maintained by other entities, but may use the loyalty identifier as it wishes. The merchant thus need only be able to extract a loyalty identifier from a single-use payment token so as to repeatedly ‘recognize’ a consumer visiting the merchant. The loyalty identifier may be used in a manner similar to that in which static payment credentials are used to recognize consumers. Thus, the advent of single-use payment credentials need not affect a merchant's ability to recognize consumers.

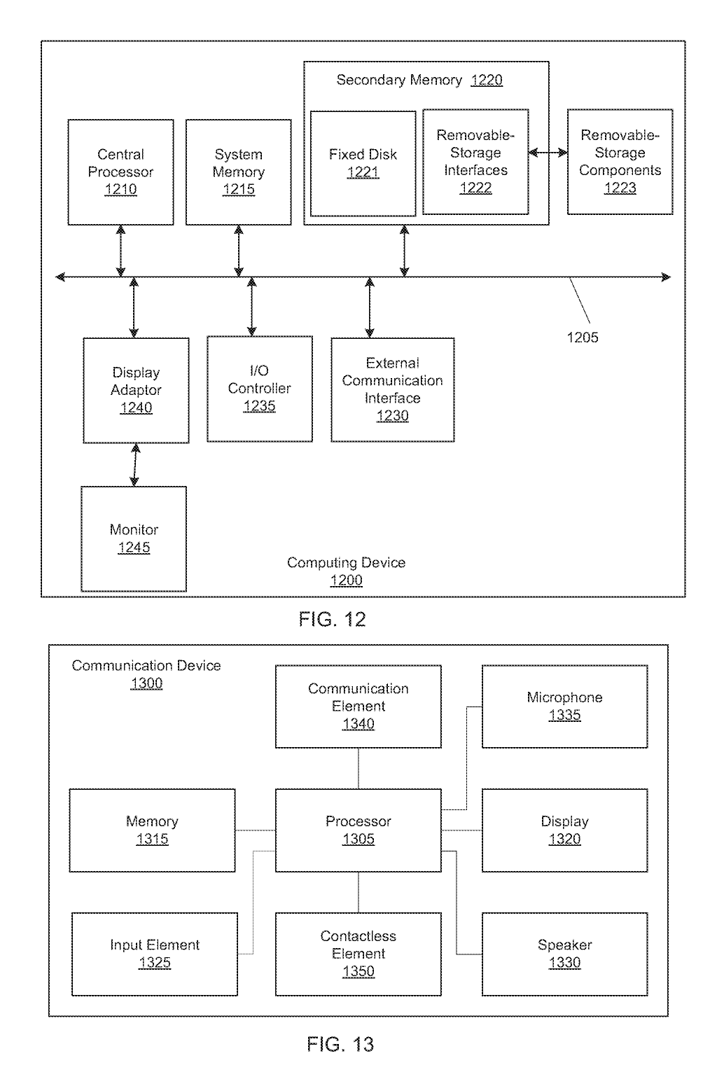

FIG. 12 illustrates an example of a computing device (1200) in which various aspects of the disclosure may be implemented. The computing device (1200) may be suitable for storing and executing computer program code. The various participants and elements in the previously described system diagrams may use any suitable number of subsystems or components of the computing device (1200) to facilitate the functions described herein.

The computing device (1200) may include subsystems or components interconnected via a communication infrastructure (1205) (for example, a communications bus, a cross-over bar device, or a network). The computing device (1200) may include at least one central processor (1210) and at least one memory component in the form of computer-readable media.

The memory components may include system memory (1215), which may include read only memory (ROM) and random access memory (RAM). A basic input/output system (BIOS) may be stored in ROM. System software may be stored in the system memory (1215) including operating system software.

The memory components may also include secondary memory (1220). The secondary memory (1220) may include a fixed disk (1221), such as a hard disk drive, and, optionally, one or more removable-storage interfaces (1222) for removable-storage components (1223).

The removable-storage interfaces (1222) may be in the form of removable-storage drives (for example, magnetic tape drives, optical disk drives, floppy disk drives, etc.) for corresponding removable storage-components (for example, a magnetic tape, an optical disk, a floppy disk, etc.), which may be written to and read by the removable-storage drive.

The removable-storage interfaces (1222) may also be in the form of ports or sockets for interfacing with other forms of removable-storage components (1223) such as a flash memory drive, external hard drive, or removable memory chip, etc.

The computing device (1200) may include an external communications interface (1230) for operation of the computing device (1200) in a networked environment enabling transfer of data between multiple computing devices (1200). Data transferred via the external communications interface (1230) may be in the form of signals, which may be electronic, electromagnetic, optical, radio, or other types of signal.

The external communications interface (1230) may enable communication of data between the computing device (1200) and other computing devices including servers and external storage facilities. Web services may be accessible by the computing device (1200) via the communications interface (1230).

The external communications interface (1230) may also enable other forms of communication to and from the computing device (1200) including, voice communication, near field communication, Bluetooth, etc.

The computer-readable media in the form of the various memory components may provide storage of computer-executable instructions, data structures, program modules, and other data. A computer program product may be provided by a computer-readable medium having stored computer-readable program code executable by the central processor (1210).

A computer program product may be provided by a non-transient computer-readable medium, or may be provided via a signal or other transient means via the communications interface (1230).

Interconnection via the communication infrastructure (1205) allows a central processor (1210) to communicate with each subsystem or component and to control the execution of instructions from the memory components, as well as the exchange of information between subsystems or components.

Peripherals (such as printers, scanners, cameras, or the like) and input/output (I/O) devices (such as a mouse, touchpad, keyboard, microphone, joystick, or the like) may couple to the computing device (1200) either directly or via an I/O controller (1235). These components may be connected to the computing device (1200) by any number of means known in the art, such as a serial port.

One or more monitors (1245) may be coupled via a display or video adapter (1240) to the computing device (1200).

FIG. 13 shows a block diagram of a communication device (1300) that may be used in embodiments of the disclosure. The communication device (1300) may be a cell phone, a feature phone, a smart phone, a satellite phone, or a computing device having a phone capability.

The communication device (1300) may include a processor (1305) (e.g., a microprocessor) for processing the functions of the communication device (1300) and a display (1320) to allow a consumer to see the phone numbers and other information and messages. The communication device (1300) may further include an input element (1325) to allow a consumer to input information into the device (e.g., input buttons, touch screen, etc.), a speaker (1330) to allow the consumer to hear voice communication, music, etc., and a microphone (1335) to allow the consumer to transmit his or her voice through the communication device (1300).

The processor (1310) of the communication device (1300) may connect to a memory (1315). The memory (1315) may be in the form of a computer-readable medium that stores data and, optionally, computer-executable instructions.

The communication device (1300) may also include a communication element (1340) for connection to communication channels (e.g., a cellular telephone network, data transmission network, Wi-Fi network, satellite-phone network, Internet network, Satellite Internet Network, etc.). The communication element (1340) may include an associated wireless transfer element, such as an antenna.

The communication element (1340) may include a subscriber identity module (SIM) in the form of an integrated circuit that stores an international mobile subscriber identity and the related key used to identify and authenticate a subscriber using the communication device (1300). One or more subscriber identity modules may be removable from the communication device (1300) or embedded in the communication device (1300).

The communication device (1300) may further include a contactless element (1350), which is typically implemented in the form of a semiconductor chip (or other data storage element) with an associated wireless transfer element, such as an antenna. The contactless element (1350) may be associated with (e.g., embedded within) the communication device (1300) and data or control instructions transmitted via a cellular network may be applied to the contactless element (1350) by means of a contactless element interface (not shown). The contactless element interface may function to permit the exchange of data and/or control instructions between mobile device circuitry (and hence the cellular network) and the contactless element (1350).

The contactless element (1350) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth, infra-red, or other data transfer capability that can be used to exchange data between the communication device (1300) and an interrogation device. Thus, the communication device (1300) may be capable of communicating and transferring data and/or control instructions via both a cellular network and near field communications capability.

The data stored in the memory (1315) may include: operation data relating to the operation of the communication device (1300), personal data (e.g., name, date of birth, identification number, etc.), financial data (e.g., bank account information, a bank identification number (BIN), credit or debit card number information, account balance information, expiration date, loyalty provider account numbers, etc.), transit information (e.g., as in a subway or train pass), access information (e.g., as in access badges), etc. A consumer may transmit this data from the communication device (1300) to selected receivers.

The communication device (1300) may be, amongst other things, a notification device that can receive alert messages and access reports, a portable merchant device that can be used to transmit control data identifying a discount to be applied, as well as a portable consumer device that can be used to make payments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method for providing payment credentials usable in a transaction, the method being conducted at a token processor and comprising the steps of:
receiving a request for single-use payment credentials from a communication device of a consumer,
obtaining or generating single-use payment credentials;
obtaining or generating a loyalty identifier being uniquely associated with the consumer; and
transmitting the single-use payment credentials and the loyalty identifier to the communication device as a combined single-use payment token capable of being presented using the communication device.

2. The method as claimed in claim 1, wherein the loyalty identifier is the same for all requests by the consumer for single-use payment credentials, such that the loyalty identifier is usable by a merchant in updating a record of the consumer, wherein the record is a record of transactions by the consumer at the merchant, wherein the record includes details of products purchased from the merchant by the consumer.

3. The method as claimed in claim 1, wherein the loyalty identifier is the same for all requests by the consumer for single-use payment credentials usable at a specific merchant such that the loyalty identifier is usable by the specific merchant in updating a record of the consumer, wherein the record is a record of transactions by the consumer at the merchant, wherein the record includes details of products purchased from the merchant by the consumer.

4. (canceled)

5. The method as claimed in claim 1, wherein the step of obtaining or generating a loyalty identifier being uniquely associated with the consumer includes obtaining a loyalty identifier included in the request.

6. The method as claimed in claim 1, wherein the step of obtaining or generating a loyalty identifier being uniquely associated with the consumer includes the steps of:
obtaining a consumer identifier included in the request; and
using the consumer identifier to query a database and obtain a loyalty identifier associated with the consumer identifier.

7. The method as claimed in claim 1, wherein the step of transmitting the single-use payment credentials and the loyalty identifier to the communication device as a combined single-use payment token includes a step of encoding the single-use payment credentials and the loyalty identifier into one or more of the group of: a quick response (QR) code; an audio stream or near-sound communication audio stream; an optical character recognition code; a near field communication data stream; or a visible light communication data stream.

8. The method as claimed in claim 1, wherein the method includes the step of:
obtaining coupon information corresponding to one or more coupons;
and wherein the step of transmitting the single-use payment credentials and the loyalty identifier to the communication device as a combined single-use payment token includes transmitting the single-use payment credentials, the loyalty identifier and coupon information to the communication device as a combined single-use payment token.

9. A method for providing payment credentials usable in a transaction, the method being conducted at a communication device of a consumer and comprising the steps of:
transmitting a request for single-use payment credentials;
receiving single-use payment credentials;
wherein the single-use payment credentials and a loyalty identifier are received as a combined single-use payment token capable of being presented using the communication device; or
wherein the single-use payment credentials are received and locally combined with a loyalty identifier to form a single-use payment token;
presenting the single-use payment credentials and the loyalty identifier as a combined single-use payment token to a payment acceptance device and wherein the loyalty identifier is uniquely associated with the consumer.

10. The method as claimed in claim 9, wherein the step of transmitting a request for single-use payment credentials includes a loyalty identifier in the request.

11. The method as claimed in claim 9, wherein the step of transmitting a request for single-use payment credentials includes a consumer identifier in the request.

12. The method as claimed in claim 9, wherein the step of receiving single-use payment credentials and a loyalty identifier as a combined single-use payment token includes receiving the combined single-use payment token from a token processor.

13. The method as claimed in claim 9, wherein locally combining single-use payment credentials and a loyalty identifier as a combined single-use payment token includes:
receiving single-use payment credentials from a token processor;
obtaining a loyalty identifier being uniquely associated with the consumer, and
combining the single-use payment credentials and loyalty identifier into a combined single-use payment token.

14. The method as claimed in claim 13, wherein the step of obtaining a loyalty identifier being uniquely associated with the consumer obtains the loyalty identifier from a digital memory of the communication device.

15. A method for providing payment credentials usable in a transaction, the method being conducted at a payment acceptance device of a merchant and comprising the steps of:
receiving single-use payment credentials and a loyalty identifier as a single-use payment token being presented by a communication device of a consumer, wherein the loyalty identifier is uniquely associated with the consumer;
extracting the loyalty identifier from the single-use payment token; and
updating a record of the consumer associated with the loyalty identifier.

16. The method as claimed in claim 15, wherein the method includes the step of transmitting the single-use payment token to a payment processing server for transaction processing.

17. The method as claimed in claim 15, wherein the method includes the step of extracting single-use payment credentials from the single-use payment token and transmitting the single-use payment credentials to a payment processing server for transaction processing.

18. The method as claimed in claim 15, wherein the record is a record of transactions by the consumer associated with the loyalty identifier at the merchant, and wherein the record includes details of products purchased from the merchant by the consumer.

19. A system for providing payment credentials usable in a transaction, the system including a token processor comprising:
a request receiving component for receiving a request for single-use payment credentials from a communication device of a consumer;
a payment credential component for obtaining or generating single-use payment credentials;
a loyalty component for obtaining or generating a loyalty identifier being uniquely associated with the consumer; and
a transmitting component for transmitting the single-use payment credentials and the loyalty identifier to the communication device as a combined single-use payment token capable of being presented using the communication device.

20. The system as claimed in claim 19, wherein the loyalty identifier is a unique number which is the same for all requests by the consumer for single-use payment credentials, such that the loyalty identifier is usable by a merchant in updating a record of the consumer.

21. The system as claimed in claim 19, wherein the loyalty identifier is a unique number which is the same for all requests by the consumer for single-use payment credentials usable at a specific merchant such that the loyalty identifier is usable by the specific merchant in updating a record of the consumer.

22. The system as claimed in claim 19, wherein the system includes a plurality of communication devices, each communication device having:
a request transmitting component for transmitting a request for single-use payment credentials;
a receiving component for receiving the single-use payment credentials and the loyalty identifier as a combined single-use payment token capable of being presented using the communication device; and
a token presentation component for presenting the single-use payment token to a payment acceptance device.

23. The system as claimed in claim 22, wherein the request transmitting component is configured to include a loyalty identifier in the request.

24. The system as claimed in claim 22, wherein the request transmitting component is configured to include a consumer identifier in the request.

25. The system as claimed in claim 23, wherein the loyalty component is configured to obtain a loyalty identifier included in the request.

26. The system as claimed in claim 24, wherein the loyalty component is configured to obtain a loyalty identifier by obtaining a consumer identifier included in the request and using the consumer identifier to query a database and obtain a loyalty identifier associated with the consumer identifier.

27. The system as claimed in claim 19, wherein the system includes a plurality of payment acceptance devices of merchants, each acceptance device having:
a receiving component for receiving a single-use payment token being presented by a communication device;
an identifier extraction component for extracting a loyalty identifier from the single-use payment token; and
an updating component for updating a record associated with the loyalty identifier.

28. The system as claimed in claim 27, wherein each payment acceptance device further includes a transmitting component for transmitting the single-use payment token to a payment processing server for transaction processing.

29. The system as claimed in claim 27, wherein each payment acceptance device includes a payment credential extracting component for extracting single-use payment credentials from the single-use payment token and for transmitting the single-use payment credentials to a payment processing server for transaction processing.

30. A computer program product for providing payment credentials usable in a transaction, the computer program product comprising a computer-readable medium having stored computer-readable program code for performing the steps of:
receiving a request for single-use payment credentials from a communication device of a consumer;
obtaining or generating single-use payment credentials;
obtaining or generating a loyalty identifier being uniquely associated with the consumer;
transmitting the single-use payment credentials and the loyalty identifier to the communication device as a combined single-use payment token capable of being presented using the communication device.
